(19) United States
(12) Patent Application Publication
(10) Pub. No.: US 2026/0187848 A1
(43) Pub. Date: Jul. 2, 2026

(54) VIDEO COMPRESSION METHOD AND APPARATUS, AND DEVICE AND SYSTEM

(71) Applicant: DOUYIN VISION CO., LTD., Beijing (CN)

(72) Inventors: Danying WANG, Beijing (CN); Dongbo ZHANG, Beijing (CN); Yuzhong CHEN, Beijing (CN)

(21) Appl. No.: 19/130,099

(22) PCT Filed: Mar. 4, 2024
(86) PCT No.: PCT/CN2024/079944

§ 371 Date: May 14, 2025

(30) Foreign Application Priority Data
Mar. 16, 2023 (CN) 202310272000.6

(51) Int. Cl. G06T 9/00; G06T 3/4038; G06T 7/10

(52) U.S. Cl. CPC G06T 9/00; G06T 3/4038; G06T 7/10; G06T 2207/20132

(57) ABSTRACT

The present disclosure provides a video compression method and apparatus, and a device. The method includes: obtaining multiple videos of multiple views associated with a target object, where the multiple views are in a one-to-one correspondence with the multiple videos, and each video image in each of the multiple videos includes a time stamp; cropping each video image in the multiple videos to obtain a target image corresponding to each video image in each of the multiple videos, where the target image includes the target object, and the target image includes a same time stamp as a corresponding video image; determining a stitched image based on multiple target images with a same time stamp to obtain multiple stitched images; and performing compression processing on the multiple stitched images to obtain video compression data associated with the videos of the multiple views.

### CROSS-REFERENCE TO RELATED APPLICATION(S)

The present application is a U.S. National Stage application under 35 U.S.C. § 371 of International Application No. PCT/CN2024/079944, filed on Mar. 4, 2024, which is based on and claims priority to Chinese Patent Application No. 202310272000.6, filed on Mar. 16, 2023, titled “VIDEO COMPRESSION METHOD AND APPARATUS, AND DEVICE AND SYSTEM”, which are incorporated herein by reference in their entireties.

### TECHNICAL FIELD

Embodiments of the present disclosure relate to the technical field of video processing, and in particular, to a video compression method and apparatus, and a device and a system.

### BACKGROUND

In a virtual reality (VR) application, a server can send videos of a virtual object in multiple views to a VR device, so that the VR device can accurately display images of the virtual object in different views. Therefore, compression processing performed by the server on the videos in the multiple views is particularly important.

At present, the server can perform compression processing on a video in each of the multiple views to obtain video compression data of multiple videos in the multiple views.

### SUMMARY

In a first aspect, the present disclosure provides a video compression method. The method includes:
obtaining multiple videos of multiple views associated with a target object, where the multiple views are in a one-to-one correspondence with the multiple videos, and each video image in each of the multiple videos includes a time stamp;
cropping each video image in the multiple videos to obtain a target image corresponding to each video image in each of the multiple videos, where the target image includes the target object, and the target image includes a same time stamp as a corresponding video image;
determining a stitched image based on multiple target images with a same time stamp to obtain multiple stitched images; and
performing compression processing on the multiple stitched images to obtain video compression data associated with the videos of the multiple views.

In a second aspect, the present disclosure provides a video compression apparatus. The video compression apparatus includes an obtaining module, a cropping module, a determining module, and a compressing module.

The obtaining module is configured to obtain multiple videos of multiple views associated with a target object, where the multiple views are in a one-to-one correspondence with the multiple videos, and each video image in each of the multiple videos includes a time stamp;
the cropping module is configured to crop each video image in the multiple videos to obtain a target image corresponding to each video image in each of the multiple videos, where the target image includes the target object, and the target image includes a same time stamp as a corresponding video image;
the determining module is configured to determine a stitched image based on multiple target images with a same time stamp to obtain multiple stitched images; and
the compressing module is configured to perform compression processing on the multiple stitched images to obtain video compression data associated with the videos of the multiple views.

In a third aspect, an embodiment of the present disclosure provides a video compression device. The video compression device includes a processor and a memory.

The memory stores computer-executable instructions; and
the processor executes the computer-executable instructions stored in the memory, to enable the processor to perform the video compression method according to the first aspect and various implementations of the first aspect.

In a fourth aspect, an embodiment of the present disclosure provides a video processing system. The video processing system includes the video compression device according to various implementations of the third aspect or video compression apparatus according to various implementations of the second aspect, and a video decompression device configured to receive video compression data sent by the video compression device/apparatus and decompress the video compression data.

In a fifth aspect, an embodiment of the present disclosure provides a computer-readable storage medium storing computer-executable instructions which, when executed by a processor, cause the processor to perform the video compression method according to the first aspect and various implementations of the first aspect.

In a sixth aspect, an embodiment of the present disclosure provides a computer program including instructions which, when executed by a processor, cause the processor to perform the video compression method according to the first aspect and various implementations of the first aspect.

### BRIEF DESCRIPTION OF THE DRAWINGS

To illustrate the technical solutions in the embodiments of the present disclosure or in the related art more clearly, the following briefly introduces the drawings required for describing the embodiments or the related art. Apparently, the drawings in the following description show some embodiments of the present disclosure, and a person of ordinary skill in the art may still derive other drawings from these drawings without creative efforts.

FIG. 1 is a schematic diagram of an application scenario according to an embodiment of the present disclosure;

FIG. 2 is a schematic flowchart of a video compression method according to an embodiment of the present disclosure;

FIG. 3 is a schematic diagram of cropping a video image according to an embodiment of the present disclosure;

FIG. 4 is a schematic diagram of stitching images according to an embodiment of the present disclosure;

FIG. 5 is a schematic flowchart of a method for determining a stitched image according to an embodiment of the present disclosure;

FIG. 6 is a schematic diagram of obtaining a target depth map according to an embodiment of the present disclosure;

FIG. 7 is a schematic diagram of stitching images according to an embodiment of the present disclosure;

FIG. 8 is a schematic diagram of a video compression method according to an embodiment of the present disclosure;

FIG. 9 is a schematic diagram of a structure of a video compression apparatus according to an embodiment of the present disclosure; and

FIG. 10 is a schematic diagram of a structure of a video compression device according to an embodiment of the present disclosure.

FIG. 11 is a schematic diagram of a structure of a video processing system according to an embodiment of the present disclosure.

### DETAILED DESCRIPTION OF EMBODIMENTS

Exemplary embodiments will be described in detail herein, examples of which are shown in the drawings. When the following description refers to the drawings, the same numbers in different drawings represent the same or similar elements, unless otherwise indicated. The implementations described in the following exemplary embodiments do not represent all implementations consistent with the present disclosure. Rather, they are merely examples of apparatuses and methods consistent with some aspects of the present disclosure as detailed in the appended claims.

It can be understood that before using the technical solutions disclosed in the embodiments of the present disclosure, the user should be informed of and the user's authorization should be obtained for the type, scope of use, and use scenario of the personal information involved in the present disclosure in an appropriate manner in accordance with relevant laws and regulations.

For example, in response to receiving an active request from the user, prompt information is sent to the user to explicitly prompt the user that the operation requested to be performed will require the acquisition and use of the user's personal information. This allows the user to independently select whether to provide personal information to software or hardware such as an electronic device, an application, a server, or a storage medium that performs the operation of the technical solution of the present disclosure according to the prompt information. As an optional but non-limiting implementation, the manner of sending the prompt information to the user in response to receiving the active request from the user may be, for example, a pop-up window, and the prompt information may be presented in text in the pop-up window. In addition, the pop-up window may also carry a selection control for the user to select “agree” or “disagree” to provide personal information to the electronic device.

It can be understood that the preceding process of notifying and obtaining the user's authorization is merely illustrative and does not constitute a limitation on the implementations of the present disclosure, and other manners that satisfy relevant laws and regulations may also be applied to the implementations of the present disclosure.

It can be understood that the data involved in the technical solution (including but not limited to the data itself, acquisition or use of the data) should comply with requirements of corresponding laws and regulations and related provisions. The data may include information, parameters, messages, and the like, such as stream switching indication information.

To facilitate understanding, concepts involved in the embodiments of the present disclosure are described below.

An electronic device is a device with a wireless transceiving function. The electronic device may be deployed on land, including indoors or outdoors, handheld, wearable, or vehicle-mounted. The electronic device may be a mobile phone, a tablet computer (Pad), a computer with a wireless transceiving function, a virtual reality (VR) electronic device, an augmented reality (AR) electronic device, a wireless terminal in industrial control, a vehicle-mounted electronic device, a wireless terminal in self driving, a wireless electronic device in remote medical, a wireless electronic device in a smart grid, a wireless electronic device in transportation safety, a wireless electronic device in a smart city, a wireless electronic device in a smart home, a wearable electronic device, or the like. The electronic device involved in the embodiments of the present disclosure may also be referred to as a terminal, user equipment (UE), an access electronic device, a vehicle-mounted terminal, an industrial control terminal, a UE unit, a UE station, a mobile station, a mobile terminal, a remote station, a remote electronic device, a mobile device, a UE electronic device, a wireless communication device, a UE proxy, a UE apparatus, or the like. The electronic device may also be stationary or mobile.

In the related art, when compressing the multiple videos, the server needs to perform compression processing on a video frame of each of the multiple videos, resulting in low video compression efficiency. How to improve the video compression efficiency of the multiple videos of the multiple views is an urgent problem to be solved.

The present disclosure provides a video compression method and apparatus, and a device and a system to solve the technical problem of low efficiency of video compression in the related art.

The following describes an application scenario of the embodiments of the present disclosure with reference to FIG. 1.

FIG. 1 is a schematic diagram of an application scenario according to an embodiment of the present disclosure. Referring to FIG. 1, the application scenario includes a video generation device, a video compression device, and a VR device. The video generation device may generate a video of a view 1, a video of a view 2, and a video of a view 3 that each include a target object. The video generation device may send the video of the view 1, the video of the view 2, and the video of the view 3 to the video compression device. The video compression device may separately perform compression processing on the videos of the multiple views and send video compression data of the multiple views to the VR device. After receiving the video compression data of the multiple views, the VR device may decompress the video compression data and then play the videos of the multiple views.

It should be noted that FIG. 1 is merely exemplary to illustrate the application scenario of the embodiments of the present disclosure, and is not intended to limit the application scenario of the embodiments of the present disclosure.

In the related art, the server can send the videos of the virtual object of the multiple views to the VR device, and the VR device can accurately display images of the virtual object in different views, thereby improving the display effect of the VR device. At present, the server can perform compression processing on the video in each of the multiple views to obtain the video compression data of the multiple videos of the multiple views. However, when compressing the multiple videos, the server needs to analyze pixels in a video frame of each of the multiple videos. There are a large number of pixels to be analyzed, resulting in low video compression efficiency.

To solve the problem in the related art, an embodiment of the present disclosure provides a video compression method. A video compression device can obtain multiple videos of multiple views associated with a target object, where each video image in each of the multiple videos includes a time stamp. The video compression device crops each video image in the multiple videos to obtain a target image corresponding to each video image in each of the multiple videos, where the target image includes the target object. The video compression device determines a target depth map and/or a target transparency map corresponding to each of multiple target images for any group of the multiple target images with a same time stamp, stitches the multiple target images, the multiple target depth maps, and/or the multiple target transparency maps to obtain a stitched image corresponding to the multiple target images with the same time stamp, and performs compression processing on multiple stitched images to obtain video compression data associated with the videos of the multiple views. In this way, because the video compression device can perform cropping processing on the video images, the number of pixels in the video frame needs to be analyzed by the video compression device during video compression becomes smaller. Moreover, the video compression device can stitch the target images of the multiple views with the same time stamp. Therefore, the video compression device only needs to compress one stream of stitched image data, reducing the number of input streams of the video compression device and thus improving the efficiency of video compression. Moreover, the stitched image may further include depth information of the image, transparency information of the image, and pixel information of the target object, thereby improving the accuracy and efficiency of decompressing the video compression data.

The technical solutions of the present disclosure and how the technical solutions of the present disclosure solve the preceding technical problems are described in detail below with specific embodiments. The following specific embodiments may be combined with each other, and the same or similar concepts or processes may not be described in detail in some embodiments. The embodiments of the present disclosure are described below with reference to the drawings.

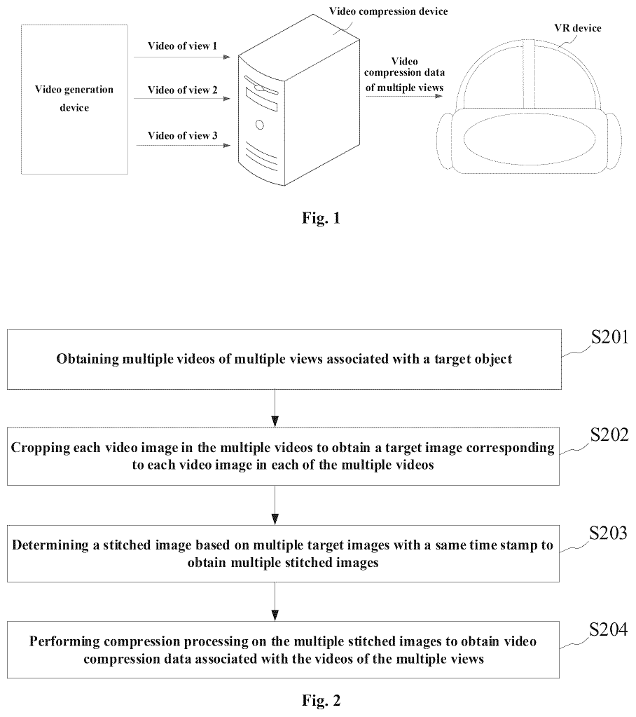

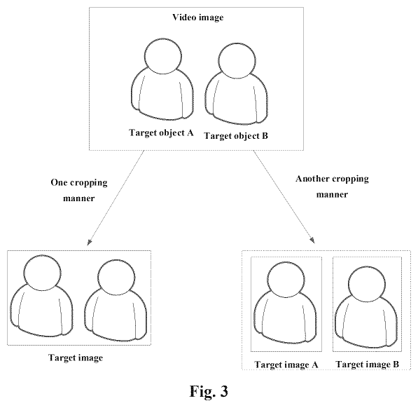

FIG. 2 is a schematic flowchart of a video compression method according to an embodiment of the present disclosure. Referring to FIG. 2, the method may include step S201 to step S204.

In S201, multiple videos of multiple views associated with a target object are obtained.

An execution body of the embodiments of the present disclosure may be a video compression device or a video compression apparatus provided in the video compression device. The video compression apparatus may be implemented based on software, or may be implemented based on a combination of software and hardware, which is not limited in the embodiments of the present disclosure.

The multiple views may be in a one-to-one correspondence with the multiple videos. For example, the multiple videos may include a video with a view of 5 degrees, a video with a view of 10 degrees, a video with a view of 15 degrees, etc. The video direction refers to, for example, a direction of capturing a video. Each of the multiple views may correspond to one video, and each of the multiple videos may include the target object. For example, the target object may be a virtual object, a virtual character, or the like, which is not limited in the embodiments of the present disclosure.

Each video image in each of the multiple videos may include a time stamp. For example, when a video generation device generates a video of the target object at multiple angles, each image in each video may include a time stamp. In this way, a VR image including the target object may be synthesized based on a video image with a same time stamp in the multiple videos.

Optionally, the video compression device receives the multiple videos of the multiple views associated with the target object sent by the video generation device. For example, the video generation device may be a rendering device, an electronic device, or the like, which is not limited in the embodiments of the present disclosure. The video generation device may obtain motion capture videos of the multiple views and synthesize the multiple videos of the multiple views based on the motion capture videos of the multiple views. Each of the multiple videos includes a virtual character. The video generation device may send the multiple videos of the multiple views to the video compression device, so that the accuracy of the multiple videos of the multiple views generated by the video generation device can be improved.

It should be noted that the video compression device may also obtain the multiple videos of the multiple views associated with the target object based on any feasible implementation, which is not limited in the embodiments of the present disclosure.

In S202, each video image in the multiple videos is cropped to obtain a target image corresponding to each video image in each of the multiple videos.

The target image may include the target object. For example, if the target object is at least one virtual character, the target image includes the at least one virtual character. The target image includes a same time stamp as the corresponding video image. For example, if the time stamp of the video image is a time stamp A, the time stamp of the target image obtained by cropping the video image is the time stamp A. If the time stamp of the video image is a time stamp B, the time stamp of the target image obtained by cropping the video image is the time stamp B.

Optionally, the video compression device may crop each video image in the multiple videos to obtain multiple target images. For example, if one video includes 100 video images, the video compression device may crop the 100 video images to obtain 100 target images corresponding to the 100 video images. If the multiple videos include 500 video images, the video compression device may crop the 500 video images to obtain 500 target images corresponding to the 500 video images. That is, the number of video images may be the same as the number of target images.

Optionally, the video compression device may crop each video image in the multiple videos to obtain a target image corresponding to each video image in each of the multiple videos based on the following feasible implementation: detecting position coordinates of the target object in the video image and cropping the video image based on the position coordinates to obtain the target image corresponding to the video image.

Optionally, the video compression device may determine the position coordinates of the target object in the video image based on an image detection algorithm. For example, the video compression device may process the video image based on the image detection algorithm to obtain an effective area (that is, an area where the target object is located) in the video image, and then determine coordinates of the effective area as the position coordinates of the target object in the video image. For example, the video compression device may detect a contour of the target object based on a contour detection algorithm, and then determine a maximum abscissa, a minimum abscissa, a maximum ordinate, and a minimum ordinate in the contour as the position coordinates of the target object.

Optionally, when obtaining the videos of the multiple views associated with the target object, the video compression device may also obtain a depth map and/or a transparency map associated with each video image. Therefore, the video compression device may determine the position coordinates of the target object in the video image based on the depth map and/or the transparency map.

It should be noted that the video compression device may determine the position coordinates of the target object in the video image based on any feasible implementation, which is not limited in the embodiments of the present disclosure.

Optionally, the video compression device may crop the video image based on the position coordinates. For example, the position coordinates may indicate at least one rectangular area, or may indicate at least one contour area, which is not limited in the embodiments of the present disclosure. The video compression device may crop one or more rectangular images from the video image based on the position coordinates and determine the one or more rectangular images as the target image. Alternatively, the video compression device may crop one or more contour images (images in the contour of the target object) from the video image based on the position coordinates and determine the one or more contour images as the target image, which is not limited in the embodiments of the present disclosure.

It should be noted that in a practical application process, one or more target objects may exist. Therefore, the target image corresponding to the video image may include multiple target objects or one target object (that is, the target image of each target object is cropped separately), which is not limited in the embodiments of the present disclosure.

The process of cropping the video image is described below with reference to FIG. 3.

FIG. 3 is a schematic diagram of cropping a video image according to an embodiment of the present disclosure. Referring to FIG. 3, a video image is included. The video image includes a target object A and a target object B. A video compression device (not shown in FIG. 3) may crop the target objects in the video image to obtain a target image. One cropping manner is: cropping the target object A and the target object B together to obtain one target image, where the target image includes the target object A and the target object B. Another cropping manner is: separately cropping the target object A and the target object B to obtain a target image A and a target image B, where the target object in the target image A is the target object A, and the target object in the target image B is the target object B.

In S203, a stitched image is determined based on multiple target images with a same time stamp to obtain multiple stitched images.

The video compression device may stitch the multiple target images with the same time stamp to obtain the multiple stitched images. Each of the multiple stitched images is obtained by stitching the multiple target images with the same time stamp. Different stitched images in the multiple stitched images may be associated with different time stamps. For example, if a video A includes a target image a with a time stamp 1 and a target image b with a time stamp 2, and a video B includes a target image c with a time stamp 1 and a target image d with a time stamp 2, the video compression device may stitch the target image a and the target image c to obtain a stitched image, where the target images in the stitched image all have the time stamp 1. The video compression device may stitch the target image b and the target image d to obtain another stitched image, where the target images in the stitched image all have the time stamp 2.

Optionally, when stitching the multiple target images, the video compression device may stitch the multiple target images in the order of views associated with the multiple target images. For example, the multiple videos include a video with a view of 1 degree, a video with a view of 3 degrees, and a video with a view of 5 degrees. The video compression device may stitch the target image with the view of 1 degree and the target image with the view of 3 degrees, and then stitch the target image with the view of 5 degrees and the target image with the view of 3 degrees.

It should be noted that the video compression device may stitch the multiple target images based on any feasible implementation. For example, the video compression device stitches the multiple target images based on image similarity between the multiple target images, and target images with high similarity are stitched together, which is not limited in the embodiments of the present disclosure.

The stitched image is described below with reference to FIG. 4.

FIG. 4 is a schematic diagram of stitching images according to an embodiment of the present disclosure. Referring to FIG. 4, target images of a view 1, a view 2, a view 3, and a view 4 are included. The target image of each of the multiple views includes a target object, and the target images of the multiple views have a same time stamp. The target images of the view 1, the view 2, the view 3, and the view 4 are stitched to obtain a stitched image. The target image of the view 1 is located in an upper left area of the stitched image, the target image of the view 2 is located in an upper right area of the stitched image, the target image of the view 3 is located in a lower left area of the stitched image, and the target image of the view 4 is located in a lower right area of the stitched image. In this way, multiple input streams of the videos of the multiple views are converted into one input stream of the stitched image by stitching the multiple target images to obtain the stitched image, thereby improving the efficiency of video compression.

In S204, compression processing is performed on the multiple stitched images to obtain video compression data associated with the videos of the multiple views.

Optionally, the video compression device may compress the multiple stitched images to obtain the video compression data. For example, after obtaining a video stream of the stitched image obtained by combining the videos of the multiple views, the video compression device may compress the video stream. Because the number of video streams to be compressed is reduced and the number of pixels to be analyzed is also reduced, the efficiency of video compression can be improved.

It should be noted that the video compression device may perform the compression processing on the multiple stitched images based on any feasible implementation, which is not limited in the embodiments of the present disclosure.

Optionally, after compressing the multiple stitched images to obtain the video compression data, the video compression device may send the video compression data to an electronic device (which may be a VR device). After receiving the video compression data, the electronic device may decompress the video data and then restore the target images in the videos of the multiple views. Because the target images include the target object, the electronic device does not need to restore the pixels when decompressing, thereby improving the accuracy of decompression.

It should be noted that because the target images may include the target object, when playing the videos of the multiple views, the electronic device can also restore a background image of the videos. Because the background image of the videos may be a rendered image, the electronic device can obtain the original videos of the multiple views (including both the background image and the target images) after combining the target object with the background image.

An embodiment of the present disclosure provides a video compression method. A video compression device can obtain multiple videos in a one-to-one correspondence with multiple views associated with a target object, where each video image in each of the multiple videos includes a time stamp. The video compression device detects position coordinates of the target object in the video image and crops the video image based on the position coordinates to obtain multiple target images each including the target object and associated with each of the multiple videos, where the target image includes a same time stamp as the corresponding video image. The video compression device determines a stitched image based on multiple target images with a same time stamp to obtain multiple stitched images and performs compression processing on the multiple stitched images to obtain video compression data associated with the videos of the multiple views. In the preceding method, because the video compression device can perform the compression processing on the target images each including the target object, the number of pixels needs to be analyzed by the video compression device becomes smaller. Moreover, the electronic device does not need to perform pixel restoration processing when decompressing, thereby improving the accuracy of decompression. Moreover, because the video compression device can stitch the multiple target images with the same time stamp, the video compression device can perform the compression processing on one video stream of the stitched image without performing the compression processing on multiple video streams of the multiple views, thereby improving the efficiency of video compression.

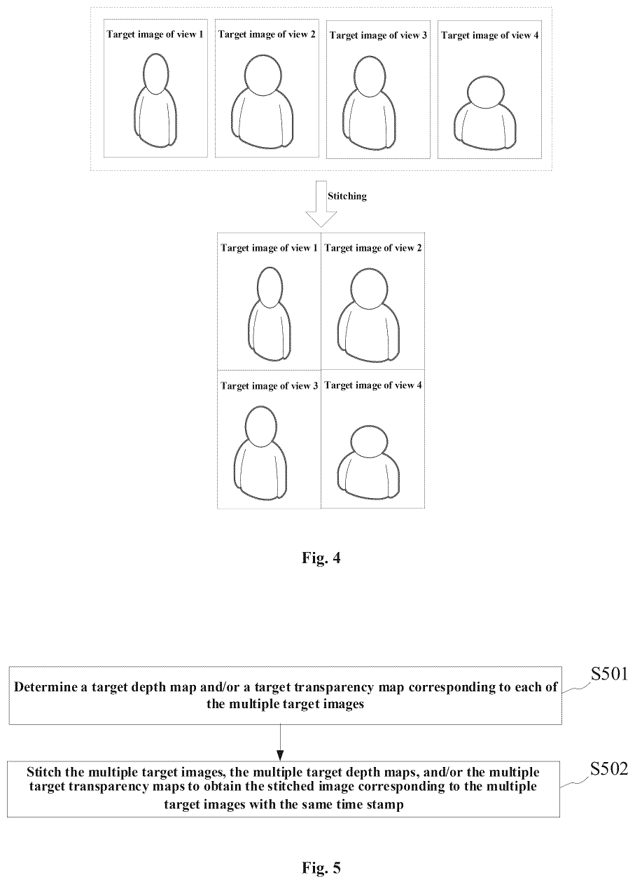

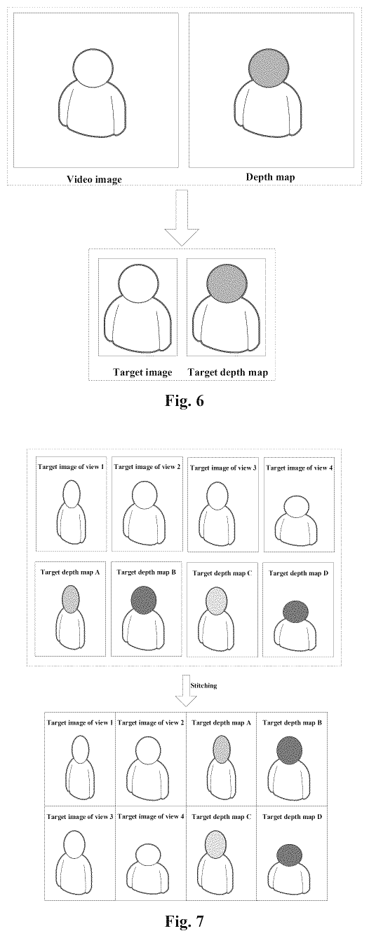

On the basis of the embodiment shown in FIG. 2, the method for determining the stitched image based on the multiple target images with the same time stamp in the preceding video compression method is further described below with reference to FIG. 5.

FIG. 5 is a schematic flowchart of a method for determining a stitched image according to an embodiment of the present disclosure. Referring to FIG. 5, the method flow includes step S501 and step S502.

In S501, a target depth map and/or a target transparency map corresponding to each target image are determined.

For any group of multiple target images with a same time stamp, the video compression device may determine a target depth map and/or a target transparency map corresponding to each of the multiple target images. The target depth map may indicate image depth information of the target image, and the target transparency map may be a transparency map corresponding to the target image. For example, each pixel in the target transparency map may include three channels, namely, an R channel, a G channel, and a B channel, and an alpha channel. Information of the alpha channel may represent transparency of the pixel. Specifically, the video compression device may determine the target depth map and/or the target transparency map corresponding to each target image based on the following feasible implementation: determining a depth map and/or a transparency map of a video image corresponding to the target image and cropping the depth map and/or the transparency map based on a cropping manner of the video image corresponding to the target image to obtain the target depth map and/or the target transparency map.

Optionally, when obtaining the video image, the video compression device may also obtain a depth map and/or a transparency map corresponding to the video image. For example, when generating the videos of the multiple views, the video generation device may also generate a depth map and a transparency map corresponding to the video image in each video. Therefore, when sending the multiple videos of the multiple views to the video compression device, the video generation device may also send the depth map and the transparency map corresponding to the video image in each of the multiple videos.

It should be noted that the video compression device may determine the depth map and/or the transparency map of the video image corresponding to the target image based on any feasible implementation (for example, after obtaining the videos of the multiple views, the video compression device detects depth information and transparency information of the video image in each video to obtain the depth map and the transparency map of the video image), which is not limited in the embodiments of the present disclosure.

Optionally, the video compression device may crop the depth map and/or the transparency map corresponding to the video image based on the cropping manner of the video image corresponding to the target image to obtain the target depth map and/or the target transparency map. For example, the video compression device may determine position coordinates for cropping the video image corresponding to the target image, and then crop the depth map and the transparency map based on the position coordinates to obtain the target depth map and the target transparency map.

It should be noted that the size of the target depth map and the size of the target transparency map that are associated with the target image may be the same as or different from the size of the target image, which is not limited in the embodiments of the present disclosure.

The process of obtaining the target depth map is described below with reference to FIG. 6.

FIG. 6 is a schematic diagram of obtaining a target depth map according to an embodiment of the present disclosure. Referring to FIG. 6, a video image and a depth map corresponding to the video image are included, where the depth map may indicate depth information of the video image. If the video compression device (not shown in FIG. 6) crops the video image to obtain a target image, the video compression device may crop the depth map in the same cropping manner (that is, the same position coordinates) to obtain the target depth map corresponding to the target image.

It should be noted that the method for obtaining the target transparency map corresponding to the target image is the same as the method in the embodiment shown in FIG. 6, and details are not described again in the embodiments of the present disclosure.

In S502, the multiple target images, the multiple target depth maps, and/or the multiple target transparency maps are stitched to obtain a stitched image corresponding to the multiple target images with the same time stamp.

Optionally, the video compression device may stitch the multiple target images with the same time stamp and the multiple target depth maps corresponding to the multiple target images to obtain a stitched image corresponding to the multiple target images with the same time stamp.

Optionally, the video compression device may stitch the multiple target images with the same time stamp and the multiple target transparency maps corresponding to the multiple target images to obtain a stitched image corresponding to the multiple target images with the same time stamp.

Optionally, the video compression device may stitch the multiple target images with the same time stamp, the multiple target transparency maps corresponding to the multiple target images, and the multiple target depth maps corresponding to the multiple target images to obtain a stitched image corresponding to the multiple target images with the same time stamp.

In this way, the stitched image may include the depth information and the transparency information of the target image, thereby improving the decoding efficiency and decoding accuracy of the video compression data.

Specifically, the video compression device may obtain the stitched image corresponding to the multiple target images with the same time stamp based on the following feasible implementation: obtaining a bit width of each target depth map, quantizing depth information of the target depth map to obtain a quantized depth map when the bit width is greater than a preset bit width, and stitching the multiple target images, the multiple quantized depth maps, and/or the multiple target transparency maps to obtain the stitched image corresponding to the multiple target images with the same time stamp.

The bit width of the target depth map may be 4 kb, 8 kb, etc., which is not limited in the embodiments of the present disclosure. It should be noted that the bit width of the target depth map is determined by the depth map. In the embodiments of the present disclosure, after obtaining the target depth map, the video compression device may obtain the bit width of the target depth map.

The preset bit width is a maximum bit width that can be processed by an encoder. For example, the preset bit width may be set arbitrarily or based on a parameter of the encoder. If the encoder can process data with a maximum size of 8 kb, the preset bit width may be 8 kb. In this way, when the bit width of the target depth map is greater than the preset bit width, the video compression device can actively quantize the target depth map to avoid the loss of depth information caused by random quantization of the depth map by the encoder, thereby improving the accuracy of the video compression data.

The video compression device quantizes the depth of the target depth map to obtain the quantized depth map. Specifically, the video compression device obtains near clipping plane information and far clipping plane information of the target depth map, determines, for any pixel in the target depth map, a physical depth of the pixel based on the near clipping plane information, the far clipping plane information, the bit width, and a pixel value of the pixel, and determines the quantized depth map based on the physical depth of each pixel in the target depth map and a preset target quantization bit width.

The near clipping plane information may indicate the closest depth distance from a camera in the target depth map, and the far clipping plane information may indicate the farthest depth distance from the camera in the target depth map. Optionally, when obtaining the depth map, the video compression device may obtain the near clipping plane information and the far clipping plane information in the depth map. Alternatively, the video compression device may obtain the near clipping plane information and the far clipping plane information of the target depth map based on any other feasible implementation, which is not limited in the embodiments of the present disclosure.

Optionally, the video compression device may determine the physical depth of the pixel in the target depth map based on the following formula:

$${depth}_{real} = \frac{D}{{2}^{N} - 1} ( zfar - znear ) + znear$$

depthᵣₑₐₗ is the physical depth of the pixel, N is the bit width of the target depth map, D is the pixel value of the pixel, zfar is the far clipping plane depth, and znear is the near clipping plane depth.

The video compression device may determine the physical depth of each pixel in the target depth map based on the preceding formula.

Optionally, the video compression device determines the quantized depth map based on the physical depth of each pixel in the target depth map and the preset bit width. Specifically, the video compression device determines a physical depth range associated with the target depth map based on the physical depth of each pixel, and determines the quantized depth map based on the physical depth range, the physical depth of each pixel, and the preset bit width.

For example, if the physical depth corresponding to the pixel with the largest physical depth in the target depth map is a depth A, and the physical depth corresponding to the pixel with the smallest physical depth in the target depth map is a depth B, the physical depth range of the target depth map is (depth B, depth A).

Optionally, the video compression device may determine the quantized depth map based on the following formula:

$${D}^{′} = \frac{{depth}_{real}}{{2}^{{N}^{′}}} ( {d}_{far} - {d}_{near} ) + {d}_{near}$$

D′ is the pixel value corresponding to the quantized pixel, depthᵣₑₐₗ is the physical depth of the pixel, N′ is the preset bit width, d_{far} is the maximum value of the physical depth range, and dₙₑₐᵣ is the minimum value of the physical depth range.

The video compression device may obtain the pixel value of each pixel in the target depth map after quantization based on the preceding formula, and then may obtain the quantized depth map.

After obtaining the quantized depth map corresponding to each target depth map, the video compression device may stitch the multiple target images, the multiple quantized depth maps, and/or the multiple target transparency maps to obtain the multiple stitched images.

Optionally, after the video compression device quantizing the target depth map to obtain the quantized depth map, the physical depth range associated with the target depth map may be further included in the video compression data generated by the video compression device, so that the electronic device can decompress the video compression data more conveniently, thereby improving the efficiency of decompression by the electronic device.

Optionally, the target transparency map compressed by the video compression device is YUV data. Therefore, the video compression device may convert the target transparency map, and store the YUV data of the target transparency map in a format of RGB data. Because the transparency is a single channel, the transparency may be stored in any channel (for example, a B channel) of the RGB channels. YUV conversion is performed on the RGB data obtained through conversion of the target transparency map based on an RGB-to-YUV conversion formula to obtain new YUV data. When the conversion is performed based on the RGB-to-YUV conversion formula, a channel value of the RGB data in which the transparency is not stored is 0, and a channel value of the channel in which the transparency is stored is a transparency value of the transparency (for example, the transparency is stored in the B channel, and when the RGB-to-YUV conversion is performed, an R channel and a G channel are 0, and the B channel is the transparency value). Based on the preceding method, when decompressing the stitched image, the electronic device may convert the YUV data of the stitched image into the RGB data. In the related art, the target transparency map is converted into the RGB data when being decompressed, but when the target transparency map is used, the RGB data needs to be converted into the YUV data, resulting in low efficiency of decompression. Therefore, in the present disclosure, the YUV data of the target transparency map is stored in the format of the RGB data first, and then is converted through the RGB-to-YUV conversion. In this way, when decompressing the stitched image, the electronic device obtains the target transparency map in the YUV data without the need for performing the RGB-to-YUV conversion, thereby improving the efficiency of decompression.

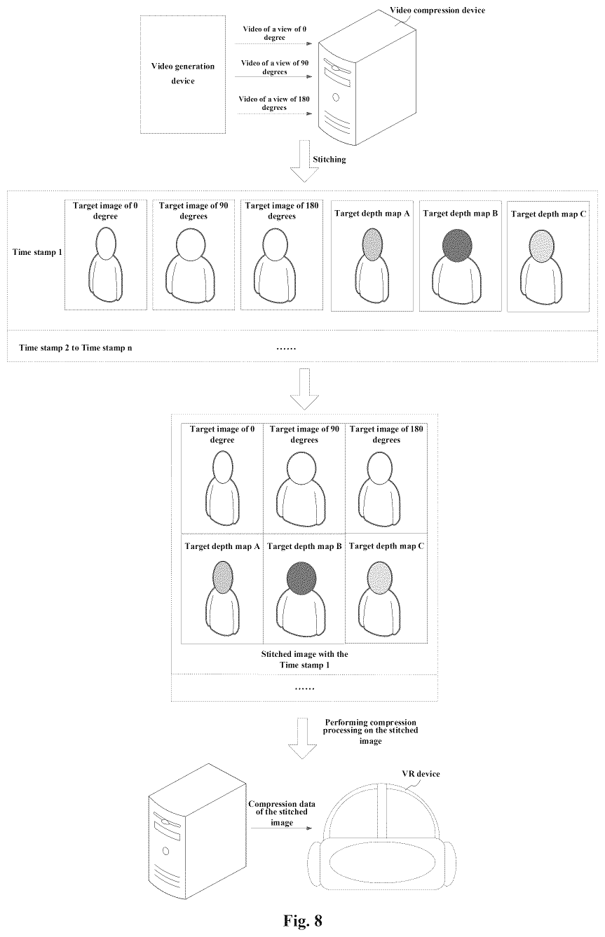

The stitched image is described below with reference to FIG. 7.

FIG. 7 is a schematic diagram of a stitched image according to an embodiment of the present disclosure. Referring to FIG. 7, target images of a view 1, a view 2, a view 3, and a view 4, and a target depth map A corresponding to the target image of the view 1, a target depth map B corresponding to the target image of the view 2, a target depth map C corresponding to the target image of the view 3, and a target depth map D corresponding to the target image of the view 4 are included, where the target image of each of the multiple views includes a target object, and the target images of the multiple views have a same time stamp.

Referring to FIG. 7, the preceding target images and target depth maps are stitched to obtain a stitched image corresponding to the moment. The target image of the view 1, the target image of the view 2, the target depth map A, and the target depth map B are located in a first row of the stitched image from left to right, and the target image of the view 3, the target image of the view 4, the target depth map C, and the target depth map D are located in a second row of the stitched image from left to right. In this way, multiple input streams of the videos of the multiple views are converted into one input stream of the stitched image by stitching the multiple target images to obtain the stitched image, thereby improving the efficiency of video compression.

An embodiment of the present disclosure provides a method for determining a stitched image. A target depth map and/or a target transparency map corresponding to each target image are determined, a bit width of each target depth map is obtained, and when the bit width is greater than a preset bit width, depth information of the target depth map is quantized to obtain a quantized depth map. Multiple target images, multiple quantized depth maps, and/or multiple target transparency maps are stitched to obtain a stitched image corresponding to the multiple target images with a same time stamp. In this way, the stitched image may include not only texture information of the target image but also depth information and transparency information of the target image, thereby improving the accuracy of decompression by the electronic device. Moreover, the multiple target images with the same time stamp may be stitched into one stitched image. Therefore, the video compression device does not need to perform compression processing on multiple video streams of the multiple views, thereby improving the efficiency of video compression.

On the basis of any of the preceding embodiments, the process of the preceding video compression method is described below with reference to FIG. 8.

FIG. 8 is a schematic diagram of a video compression method according to an embodiment of the present disclosure. Referring to FIG. 8, a video generation device, a video compression device, and a VR device are included. The video generation device may generate a video of a view of 0 degree, a video of a view of 90 degrees, and a video of a view of 180 degrees that each include a target object, and send the video of the view of 0 degree, the video of the view of 90 degrees, and the video of the view of 180 degrees to the video compression device.

Referring to FIG. 8, after obtaining the videos of the multiple views, the video compression device may crop multiple video images and multiple depth maps with a time stamp 1 to obtain a target image of 0 degree, a target image of 90 degrees, a target image of 180 degrees, a target depth map A corresponding to the target image of 0 degree, a target depth map B corresponding to the target image of 90 degrees, and a target depth map C corresponding to the target image of 180 degrees. The video compression device may also obtain the preceding images with a time stamp 2 to a time stamp n, which is not described in the embodiments of the present disclosure again.

Referring to FIG. 8, the video compression device may stitch the preceding images with the time stamp 1 to obtain a stitched image. The target image of 0 degree, the target image of 90 degrees, and the target image of 180 degrees are located in a first row of the stitched image with the time stamp 1 from left to right, and the target depth map A, the target depth map B, and the target depth map C are located in a second row of the stitched image with the time stamp 1 from left to right. The video compression device may also stitch the preceding images with the time stamp 2 to the time stamp n based on the same stitching method, which is not described in the embodiments of the present disclosure again.

Referring to FIG. 8, the video compression device may perform compression processing on the stitched images corresponding to the multiple time stamps to obtain compression data of the stitched images and send the compression data of the stitched images to the VR device. After receiving the compression data of the stitched images, the VR device may decompress the compression data of the stitched images to obtain the target images of the multiple views. In this way, because the compression data of the stitched images includes the target image information, the depth information, and the transparency information, after receiving the compression data of the stitched images, the VR device does not need to perform pixel restoration processing and can accurately decompress the compression data of the stitched images, thereby improving the accuracy of decompression. Moreover, because the video compression device can stitch the multiple target images with the same time stamp, the video compression device can perform the compression processing on one video stream of the stitched image, thereby improving the efficiency of video compression.

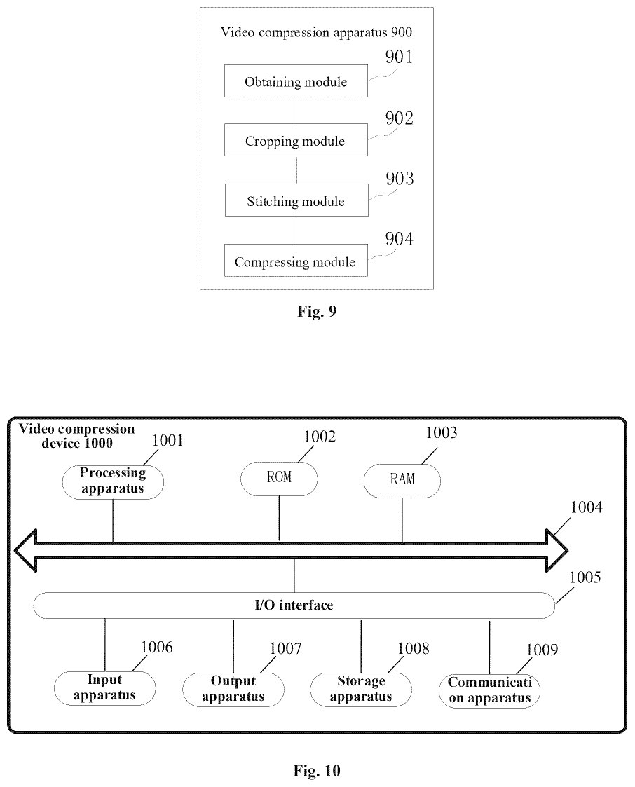

FIG. 9 is a schematic diagram of a structure of a video compression apparatus according to an embodiment of the present disclosure. Referring to FIG. 9, the video compression apparatus 900 includes an obtaining module 901, a cropping module 902, a determining module 903, and a compressing module 904.

The obtaining module 901 is configured to obtain multiple videos of multiple views associated with a target object, where the multiple views are in a one-to-one correspondence with the multiple videos, and each video image in each of the multiple videos includes a time stamp;
the cropping module 902 is configured to crop each video image in the multiple videos to obtain a target image corresponding to each video image in each of the multiple videos, where the target image includes the target object, and the target image includes a same time stamp as a corresponding video image;
the determining module 903 is configured to determine a stitched image based on multiple target images with a same time stamp to obtain multiple stitched images; and
the compressing module 904 is configured to perform compression processing on the multiple stitched images to obtain video compression data associated with the videos of the multiple views.

According to one or more embodiments of the present disclosure, the determining module 903 is further configured to:
determine a target depth map and/or a target transparency map corresponding to each of the multiple target images for any group of the multiple target images with the same time stamp; and
stitch the multiple target images, the multiple target depth maps, and/or the multiple target transparency maps to obtain the stitched image corresponding to the multiple target images with the same time stamp.

According to one or more embodiments of the present disclosure, the determining module 903 is further configured to:
determine a depth map and/or a transparency map of a video image corresponding to the target image; and
crop the depth map and/or the transparency map based on a cropping manner of the video image corresponding to the target image to obtain the target depth map and/or the target transparency map.

According to one or more embodiments of the present disclosure, the determining module 903 is further configured to:
obtain a bit width of each target depth map;
quantize depth information of the target depth map to obtain a quantized depth map when the bit width is greater than a preset bit width; and
stitch the multiple target images, the multiple quantized depth maps, and/or the multiple target transparency maps to obtain the stitched image corresponding to the multiple target images with the same time stamp.

According to one or more embodiments of the present disclosure, the determining module 903 is further configured to:
obtain near clipping plane information and far clipping plane information of the target depth map;
determine, for any pixel in the target depth map, a physical depth of the pixel based on the near clipping plane information, the far clipping plane information, the bit width, and a pixel value of the pixel; and
determine the quantized depth map based on the physical depth of each pixel in the target depth map and the preset bit width.

According to one or more embodiments of the present disclosure, the determining module 903 is further configured to:
determine a physical depth range associated with the target depth map based on the physical depth of each pixel; and
determine the quantized depth map based on the physical depth range, the physical depth of each pixel, and the preset bit width.

According to one or more embodiments of the present disclosure, the cropping module 902 is further configured to:
detect position coordinates of the target object in the video image; and
crop the video image based on the position coordinates to obtain the target image corresponding to the video image.

According to one or more embodiments of the present disclosure, the video compression data further includes the physical depth range associated with the target depth map.

The video compression apparatus provided in the embodiment of the present disclosure can be used to perform the technical solutions of the preceding method embodiments, and the implementation principles and technical effects thereof are similar, which are not described in this embodiment again.

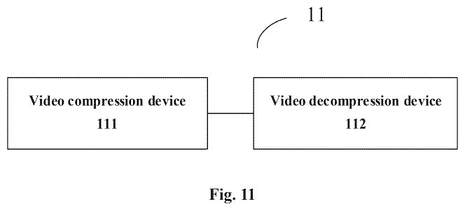

FIG. 10 is a schematic diagram of a structure of a video compression device according to an embodiment of the present disclosure. Referring to FIG. 10, FIG. 10 shows a schematic diagram of a structure of a video compression device 1000 suitable for implementing an embodiment of the present disclosure. The video compression device may include, but is not limited to, a mobile terminal such as a mobile phone, a laptop, a digital broadcast receiver, a personal digital assistant (abbreviated as PDA), a tablet computer, a portable media player (abbreviated as PMP), a vehicle-mounted terminal (such as a vehicle navigation terminal), and a fixed terminal such as a digital TV and a desktop computer. The video compression device shown in FIG. 10 is merely an example, and should not impose any limitation on the function and scope of use of the embodiments of the present disclosure.

As shown in FIG. 10, the video compression device 1000 may include a processing apparatus 1001 (e.g., a central processing unit or a graphics processing unit). The processing apparatus 1001 may perform various appropriate actions and processing according to a program stored in a read-only memory (abbreviated as ROM) 1002 or a program loaded from a storage 1008 into a random access memory (abbreviated as RAM) 1003. The RAM 1003 further stores various programs and data required for operations of the video compression device 1000. The processing apparatus 1001, the ROM 1002, and the RAM 1003 are connected to each other through a bus 1004. An input/output (I/O) interface 1005 is also connected to the bus 1004.

Usually, the following apparatus may be connected to the I/O interface 1005: an input apparatus 1006 including, for example, a touchscreen, a touchpad, a keyboard, a mouse, a camera, a microphone, an accelerometer, and a gyroscope; an output apparatus 1007 including, for example, a liquid crystal display (abbreviated as LCD), a speaker, and a vibrator; a storage 1008 including, for example, a magnetic tape and a hard disk; and a communication apparatus 1009. The communication apparatus 1009 may allow the video compression device 1000 to perform wireless or wired communication with other devices to exchange data. Although FIG. 10 shows the video compression device 1000 having various apparatuses, it should be understood that not all of the illustrated apparatuses are necessarily implemented or included. Alternatively, more or fewer apparatuses may be implemented or included.

Particularly, according to the embodiments of the present disclosure, the preceding process described with reference to the flowchart may be implemented as a computer software program. For example, an embodiment of the present disclosure includes a computer program product. The computer program product includes a computer program carried on a computer-readable medium. The computer program includes program codes for performing the method shown in the flowchart. In such an embodiment, the computer program may be downloaded and installed from a network through the communication apparatus 1009, or may be installed from the storage apparatus 1008, or may be installed from the ROM 1002. When the computer program is executed by the processing apparatus 1001, the preceding functions defined in the method of the embodiments of the present disclosure are performed.

FIG. 11 is a schematic diagram of a structure of a video processing system according to an embodiment of the present disclosure. Referring to FIG. 11, the video processing system 11 includes a video compression device 111 and a video decompression device 112. The video decompression device 112 is configured to receive video compression data sent by the video compression device and decompress the video compression data.

According to one or more embodiments of the present disclosure, the video decompression device 112 is further configured to combine a target obtained through decompression with a background image.

According to one or more embodiments of the present disclosure, the video decompression device 112 is a VR device.

It should be noted that the preceding computer-readable medium in the present disclosure may be a computer-readable signal medium or a computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program. The program may be used by or in combination with an instruction execution system, apparatus, or device. In the present disclosure, the computer-readable signal medium may include a data signal propagated in a baseband or as a part of a carrier, where the data signal carries computer-readable program codes. The propagated data signal may be in multiple forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes included on the computer-readable medium may be transmitted by any suitable medium, including but not limited to an electric wire, an optical cable, radio frequency (RF), or any suitable combination thereof.

The preceding computer-readable medium may be included in the video compression device, or may exist alone without being assembled into the video compression device.

The preceding computer-readable medium carries one or more programs which, when executed by the video compression device, cause the video compression device to perform the method shown in the preceding embodiments.

An embodiment of the present disclosure provides a computer-readable storage medium storing computer-executable instructions which, when executed by a processor, cause the processor to perform the video compression method according to the first aspect and various implementations of the first aspect.

An embodiment of the present disclosure provides a computer program product including a computer program which, when executed by a processor, causes the processor to perform the video compression method according to the first aspect and various implementations of the first aspect.

The computer program codes used to perform the operations of the present disclosure may be written in one or more programming languages or a combination thereof. The preceding programming languages include object-oriented programming languages such as Java, Smalltalk, and C++, and conventional procedural programming languages such as the C programming language or similar programming languages. The program codes may be executed entirely on a user computer, partly on a user computer, as a stand-alone software package, partly on a user computer and partly on a remote computer, or entirely on a remote computer or a video compression device. In the case involving the remote computer, the remote computer may be connected to the user computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of the system, method, and computer program product according to the embodiments of the present disclosure. In this regard, each block in the flowchart or block diagram may represent a module, a program segment, or a portion of codes, including one or more executable instructions for implementing specified logical functions. It should also be noted that in some alternative implementations, the functions indicated in the blocks may occur in an order different from those indicated in the drawings. For example, two blocks shown in succession may, in fact, be executed substantially concurrently, or the blocks may sometimes be executed in a reverse order, depending on the functionality involved. It should also be noted that each block of the block diagrams and/or flowcharts and combinations of blocks in the block diagrams and/or flowcharts may be implemented by a dedicated hardware-based system that performs the specified functions or operations, or may be implemented by a combination of dedicated hardware and computer instructions.

The units involved in the embodiments of the present disclosure may be implemented in software or hardware. The name of a unit does not constitute a limitation on the unit itself under certain circumstances. For example, a first obtaining unit may also be described as “a unit for obtaining at least two Internet Protocol addresses”.

The functions described herein above may be performed, at least partially, by one or more hardware logic components. For example, without limitation, available exemplary types of hardware logic components include: a field programmable gate array (FPGA), an application-specific integrated circuit (ASIC), an application-specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include an electrical connection with one or more wires, a portable computer disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination thereof.

It should be noted that the modifiers “one” and “multiple” mentioned in the present disclosure are illustrative and not restrictive, and a person skilled in the art should understand that they should be understood as “one or more” unless the context clearly indicates otherwise.

The names of messages or information exchanged between the plurality of apparatuses in the implementations of the present disclosure are only used for illustrative purposes, and are not intended to limit the scope of these messages or information.

The above descriptions are merely illustration of preferred embodiments of the present disclosure and the applied technical principles. Those skilled in the art should understand that the scope of disclosure involved in the present disclosure is not limited to the technical solutions formed by the specific combination of the above technical features, and should also cover other technical solutions formed by the arbitrary combination of the above technical features or equivalent features thereof without departing from the above disclosed concept, for example, the technical solutions formed by replacing the above features with the technical features having similar functions disclosed in the present disclosure (but not limited to).

In addition, although operations are depicted in a specific order, this should not be understood as requiring these operations to be performed in the specific order shown or in a sequential order. Under certain circumstances, multitasking and parallel processing may be advantageous. Similarly, although several specific implementation details are included in the above discussion, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. Rather, the specific features and actions described above are merely example forms for implementing the claims.

1. A video compression method, comprising:
obtaining multiple videos of multiple views associated with a target object, wherein the multiple views are in a one-to-one correspondence with the multiple videos, and each video image in each of the multiple videos comprises a time stamp;
cropping each video image in the multiple videos to obtain a target image corresponding to each video image in each of the multiple videos, wherein the target image comprises the target object, and the target image comprises a same time stamp as a corresponding video image;
determining a stitched image based on multiple target images with a same time stamp to obtain multiple stitched images; and
performing compression processing on the multiple stitched images to obtain video compression data associated with the videos of the multiple views.

2. The method according to claim 1, wherein the determining the stitched image based on the multiple target images with the same time stamp comprises:
determining at least one of a target depth map or a target transparency map corresponding to each of the multiple target images for any group of the multiple target images with the same time stamp; and
stitching at least one of the multiple target images, the multiple target depth maps, or the multiple target transparency maps to obtain the stitched image corresponding to the multiple target images with the same time stamp.

3. The method according to claim 2, wherein the determining at least one of the target depth map or the target transparency map corresponding to each of the multiple target images comprises:
determining at least one of a depth map or a transparency map of the video image corresponding to the target image; and
cropping at least one of the depth map or the transparency map based on a cropping manner of the video image corresponding to the target image to obtain at least one of the target depth map or the target transparency map.

4. The method according to claim 2, wherein the stitching at least one of the multiple target images, the multiple target depth maps, or the multiple target transparency maps to obtain the stitched image corresponding to the multiple target images with the same time stamp comprises:
obtaining a bit width of each target depth map;
when the bit width is greater than a preset bit width, quantizing depth information of the target depth map to obtain a quantized depth map; and
stitching at least one of the multiple target images, the multiple quantized depth maps, or the multiple target transparency maps to obtain the stitched image corresponding to the multiple target images with the same time stamp.

5. The method according to claim 4, wherein the quantizing the depth information of the target depth map to obtain the quantized depth map comprises:
obtaining near clipping plane information and far clipping plane information of the target depth map;
determining, for any pixel in the target depth map, a physical depth of the pixel based on the near clipping plane information, the far clipping plane information, the bit width, and a pixel value of the pixel; and
determining the quantized depth map based on the physical depth of each pixel in the target depth map and the preset bit width.

6. The method according to claim 5, wherein the determining the quantized depth map based on the physical depth of each pixel in the target depth map and the preset bit width comprises:
determining a physical depth range associated with the target depth map based on the physical depth of each pixel; and
determining the quantized depth map based on the physical depth range, the physical depth of each pixel, and the preset bit width.

7. The method according to claim 1, wherein the cropping each video image in the multiple videos to obtain the target image corresponding to each video image in each of the multiple videos comprises:
detecting position coordinates of the target object in the video image; and
cropping the video image based on the position coordinates to obtain the target image corresponding to the video image.

8. The method according to claim 4, wherein the video compression data further comprises the physical depth range associated with the target depth map.

9. The method according to claim 1, wherein the cropping each video image in the multiple videos to obtain the target image corresponding to each video image in each of the multiple videos comprises:
for a video image comprising a plurality of target objects in the each video image, cropping the video image comprising the plurality of target objects to obtain a target image comprising the plurality of target objects or a plurality of target images each comprising one target object.

10. The method according to claim 1, wherein the multiple videos are motion capture videos, and the target object is a virtual object or a virtual character.

11. (canceled)

12. A video compression device, comprising:
a memory, storing computer-executable instructions; and
a processor, configured to execute the computer-executable instructions stored in the memory to cause the processor to perform a video compression method, comprising:
obtaining multiple videos of multiple views associated with a target object, wherein the multiple views are in a one-to-one correspondence with the multiple videos, and each video image in each of the multiple videos comprises a time stamp;
cropping each video image in the multiple videos to obtain a target image corresponding to each video image in each of the multiple videos, wherein the target image comprises the target object, and the target image comprises a same time stamp as a corresponding video image;
determining a stitched image based on multiple target images with a same time stamp to obtain multiple stitched images; and
performing compression processing on the multiple stitched images to obtain video compression data associated with the videos of the multiple views.

13. A video processing system, comprising:
the video compression device according to claim 12; and
a video decompression device, configured to receive video compression data sent by the video compression device and decompress the video compression data.

14. The video processing system according to claim 13, wherein the video decompression device is further configured to combine a target obtained through decompression with a background image.

15. A non-transitory computer-readable storage medium, wherein the computer-readable storage medium stores computer-executable instructions, and when a processor executes the computer-executable instructions, implements a video compression method comprising:
obtaining multiple videos of multiple views associated with a target object, wherein the multiple views are in a one-to-one correspondence with the multiple videos, and each video image in each of the multiple videos comprises a time stamp;
cropping each video image in the multiple videos to obtain a target image corresponding to each video image in each of the multiple videos, wherein the target image comprises the target object, and the target image comprises a same time stamp as a corresponding video image;
determining a stitched image based on multiple target images with a same time stamp to obtain multiple stitched images; and
performing compression processing on the multiple stitched images to obtain video compression data associated with the videos of the multiple views.

16. (canceled)

17. The non-transitory computer-readable storage medium according to claim 15, wherein the determining the stitched image based on the multiple target images with the same time stamp comprises:
determining at least one of a target depth map or a target transparency map corresponding to each of the multiple target images for any group of the multiple target images with the same time stamp; and
stitching at least one of the multiple target images, the multiple target depth maps, or the multiple target transparency maps to obtain the stitched image corresponding to the multiple target images with the same time stamp.

18. The non-transitory computer-readable storage medium according to claim 17, wherein the determining at least one of the target depth map or the target transparency map corresponding to each of the multiple target images comprises:
determining at least one of a depth map or a transparency map of the video image corresponding to the target image; and
cropping the at least one of the depth map or the transparency map based on a cropping manner of the video image corresponding to the target image to obtain at least one of the target depth map or the target transparency map.

19. The non-transitory computer-readable storage medium according to claim 17, wherein the stitching at least one of the multiple target images, the multiple target depth maps, or the multiple target transparency maps to obtain the stitched image corresponding to the multiple target images with the same time stamp comprises:
obtaining a bit width of each target depth map;
when the bit width is greater than a preset bit width, quantizing depth information of the target depth map to obtain a quantized depth map; and
stitching at least one of the multiple target images, the multiple quantized depth maps, or the multiple target transparency maps to obtain the stitched image corresponding to the multiple target images with the same time stamp.

20. The non-transitory computer-readable storage medium according to claim 19, wherein the quantizing the depth information of the target depth map to obtain the quantized depth map comprises:
obtaining near clipping plane information and far clipping plane information of the target depth map;
determining, for any pixel in the target depth map, a physical depth of the pixel based on the near clipping plane information, the far clipping plane information, the bit width, and a pixel value of the pixel; and
determining the quantized depth map based on the physical depth of each pixel in the target depth map and the preset bit width.

21. The non-transitory computer-readable storage medium according to claim 20, wherein the determining the quantized depth map based on the physical depth of each pixel in the target depth map and the preset bit width comprises:
determining a physical depth range associated with the target depth map based on the physical depth of each pixel; and
determining the quantized depth map based on the physical depth range, the physical depth of each pixel, and the preset bit width.

22. The non-transitory computer-readable storage medium according to claim 15, wherein the cropping each video image in the multiple videos to obtain the target image corresponding to each video image in each of the multiple videos comprises:
detecting position coordinates of the target object in the video image; and
cropping the video image based on the position coordinates to obtain the target image corresponding to the video image.
